(19) United States
(12) Patent Application Publication
(10) Pub. No.: US 2012/0153046 A1
(43) Pub. Date: Jun. 21, 2012

(54) HERBICIDE DISPERSING SYSTEM

(76) Inventor: William Wilkerson, Mulberry, FL (US)

(21) Appl. No.: 12/970,177

(22) Filed: Dec. 16, 2010

(51) Int. Cl. B05B 9/03

(52) U.S. Cl. 239/302

(57) ABSTRACT

A herbicide dispersing system (1) that applies herbicides to weeds that have grown taller than wanted plants. A storage tank (3) supplies herbicide through a pump (5) and hose (6) to spray nozzles (7) located inside a spray bucket (4). The spray bucket is preferably V-shaped and has a cloth cover (8) made of a porous cloth material, such as a heavy felt. The spray nozzles saturate the cloth cover with herbicide through grates (18) located in the spray bucket. The herbicide then drips through the cloth cover as vegetation comes into contact with the cloth cover, thereby only allowing herbicide to be applied to vegetation that is tall enough to come into contact with the cloth cover. An additional feature of the system is a pulley system (11) that allows a user to adjust the height of the spray bucket in relation to the ground to account for varying heights of weeds.

### BACKGROUND OF THE INVENTION

This invention relates to systems and devices for controlling the growth of weeds and other unwanted vegetation, more particularly, a herbicide dispersing system that selectively applies herbicides to tall weeds and other unwanted plants without applying herbicide to shorter grass and other plants that a user does not want to harm and/or kill.

Weeds are a major problem throughout the world. Weeds crowd out and kill wanted plant life and in some cases can be dangerous to animals, such as live stock, if eaten. One example of this type of weed is cogongrass (Imperata cylindrical), which has become a major problem for landowners, land managers, foresters and governmental agencies since its introduction into the Southeastern United States. Cogongrass was accidentally introduced into Alabama as seed in packing materials from Japan. Infestations of this perennial grass forms exclusive colonies, displacing native vegetation with the exception of mature trees. In addition, cogongrass is a fire adapted species, meaning that it thrives where fire is a regular occurrence. As a result, cogongrass burns hot and readily, creating safety and property loss concerns. Wildfire in cogongrass can kill mature and seedling trees and native plants, furthering its domination. An even further problem is the harm caused to livestock from eating the razor sharp leaves of the cogongrass. Currently, the most popular method of eliminating cogongrass is with the use of herbicides. However, the herbicides used commonly kill not only the cogongrass but also all other plant life still living beneath the taller cogongrass.

Therefore, a need exists for a device that will only apply herbicide to certain tall weeds without harming any vegetation living below the taller weeds.

The relevant prior art includes the following patent references:

| Patent No. | | |
|---|---|---|
| (U.S. unless | | |
| stated otherwise) | Inventor | Issue/Publication Date |
| 2009/0199531 | Labar et al. | Aug. 13, 2009 |
| WO2009/080172 | Strasse | Jul. 02, 2009 |
| 6,802,153 | DuBois et al. | Oct. 12, 2004 |
| 6,434,880 | DuBois et al. | Aug. 20, 2002 |
| 6,010,079 | Mayfield, Jr. et al. | Jan. 04, 2000 |
| 5,842,307 | May | Dec. 01, 1998 |
| 5,826,370 | Stevens | Oct. 27, 1998 |
| 5,724,765 | Wegner | Mar. 10, 1998 |
| 5,720,127 | Robertson | Feb. 24, 1998 |
| 5,419,493 | Redway | May 30, 1995 |
| 5,280,685 | Turner | Jan. 25, 1994 |
| 4,946,102 | DeWitt et al. | Aug. 07, 1990 |
| NL8303505 | Van T Rood | Apr. 03, 1989 |
| 4,546,570 | Schaeffer | Oct. 15, 1985 |
| 4,467,558 | Rathman | Aug. 28, 1984 |
| 4,446,650 | Davis | May 08, 1984 |
| 4,320,595 | McClure et al. | Mar. 23, 1982 |
| 4,310,988 | Porter, Jr. | Jan. 19, 1982 |
| 4,187,638 | Hardy et al. | Feb. 12, 1980 |
| 4,019,278 | McKirdy | Apr. 26, 1977 |
| 3,959,924 | Allen, Jr. | Jun. 01, 1976 |
| 3,077,701 | Osmun | Feb. 19, 1963 |
| 2,223,809 | Rucker | Dec. 03, 1940 |

### SUMMARY OF THE INVENTION

The primary object of the present invention is to provide a herbicide dispersing system that will only apply herbicide to certain tall weeds without harming any vegetation living below the taller weeds.

An even further object of the present invention is to provide a herbicide dispersing system that can be mounted on vehicles, such as tractors, all terrain vehicles, etc.

Another object of the present invention is to provide a herbicide dispersing system that can be mounted on a trailer.

The present invention fulfills the above and other objects by providing a herbicide dispersing system that applies herbicides to weeds, such as cogongrass, that have grown taller than wanted plants. The device comprises at least one spray bucket that is installed on a tractor, trailer, all terrain vehicle, etc. A storage tank supplies herbicide through a pump and hose to spray nozzles located inside the spray bucket. The spray bucket is preferably V-shaped and has a cloth cover made of a porous cloth material, such as a heavy felt. The spray nozzles saturate the cloth cover with herbicide through grates located in the spray bucket. The herbicide then drips through the cloth cover as vegetation comes into contact with the cloth cover, thereby only allowing herbicide to be applied to vegetation that is tall enough to come into contact with the cloth cover. Due to the fact that the majority of weeds, especially cogongrass, grow faster and taller than other vegetation, herbicide will only be applied to the taller weeds and not to the shorter wanted vegetation. An additional feature of the device is a track and pulley system that allows a user to adjust the height of the spray bucket in relation to the ground to account for varying heights of weeds.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF THE DRAWINGS

In the following detailed description, reference will be made to the attached drawings in which:

FIG. 1 is a side view of a herbicide dispersing system of the present invention mounted on a tractor;

FIG. 2 is a front view of a herbicide dispersing system of the present invention mounted on a tractor;

FIG. 3 is a top view of a spray bucket of the present invention;

FIG. 4 is a side view of a herbicide dispersing system of the present invention mounted on a trailer; and

FIG. 5 is a rear partial cutaway view of a herbicide dispersing system of the present invention mounted on a trailer.

### DESCRIPTION OF THE PREFERRED EMBODIMENTS

For purposes of describing the preferred embodiment, the terminology used in reference to the numbered components in the drawings is as follows:

| | |
|---|---|
| 1. | herbicide dispersing system |
| 2. | tractor |
| 3. | storage tank |
| 4. | spray bucket |
| 5. | pump |
| 6. | hose |
| 7. | spray nozzle |
| 8. | cloth cover |
| 9. | spreader |
| 10. | rear portion |
| 11. | pulley system |
| 12. | vertical track |
| 13. | cable |
| 14. | wench |
| 15. | front panel |
| 16. | rear panel |
| 17. | side panel |
| 18. | grate |
| 19. | upper portion |
| 20. | porous material |
| 21. | lower portion |
| 22. | trailer |

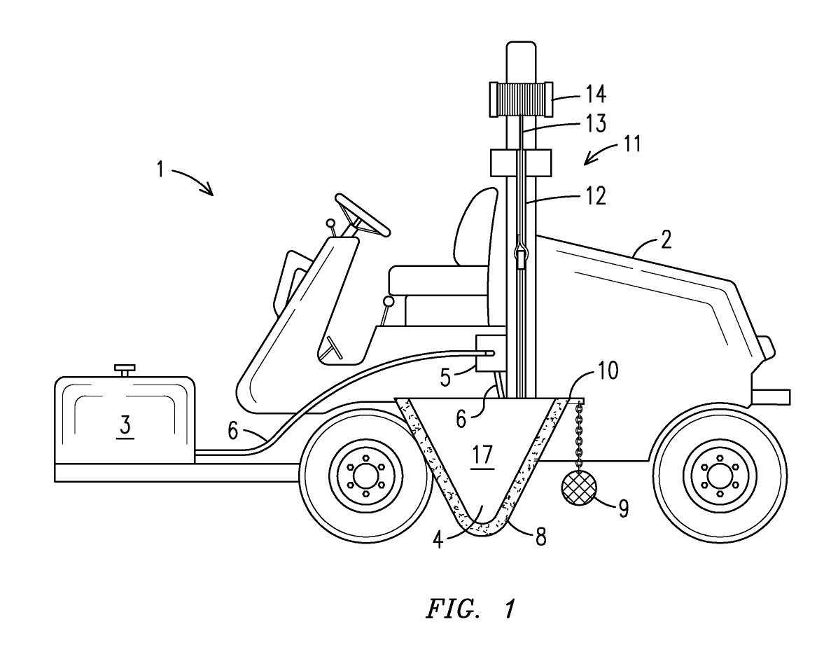

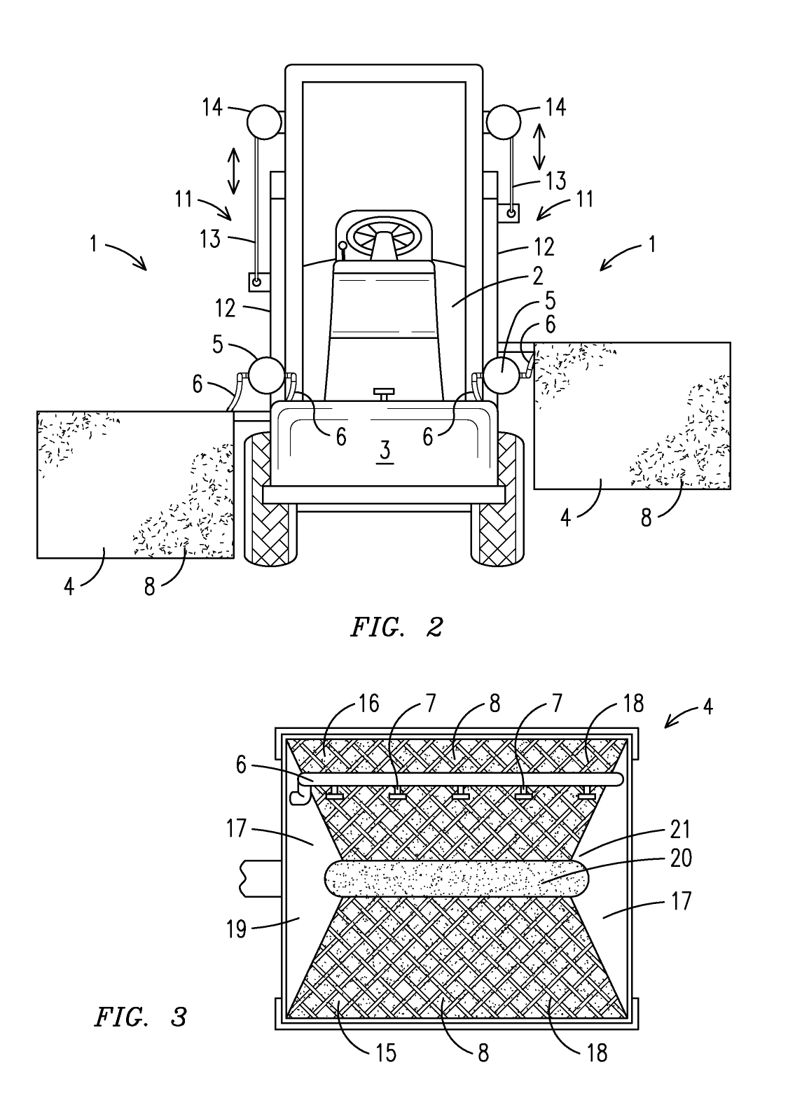

With reference to FIGS. 1 and 2, a side view and a front view of a herbicide dispersing system 1 of the present invention mounted on a tractor 2, respectively are shown. The system 1 comprises a storage tank 3 for storing herbicides mounted to the front of the tractor 2 and at least one spray bucket 4 preferably installed on either side or both sides of the tractor 2. A pump 5 pumps herbicide from the storage tank 3 through hoses 6 to spray nozzles 7 located inside the spray bucket 4, as shown in and described further in FIG. 3. The spray bucket 4 is preferably V-shaped and has a cloth cover 8 made of a porous cloth material, such as a heavy felt. The spray nozzles 7 saturate the cloth cover 8 through grates 18 located in the spray bucket, as shown in FIG. 3. A spreader 9 preferably comprising a tube covered in a cloth-like material or a porous material encased in netting hangs from a rear portion 10 of the spray bucket 4, which is then applied onto vegetation as the vegetation comes into contact with the spray bucket 4 and the cloth cover 8. The spreader 9 evens out the herbicide that is applied to vegetation by the spray bucket 4 and cloth cover 8. The spray bucket 4 may be secured directly to the tractor 2 at a predetermined height or secured to the tractor 2 via a pulley system 11 that allows a user to adjust the height of the spray bucket 4 in relation to the ground to account for varying heights of weeds. The pulley system 11 comprises a vertical track 12 slidably attached to the spray bucket 4 and a cable 13 that raises and lowers the spray bucket 4 along the vertical track 12 via a wench 14, thereby allowing a user to adjust the height of the spray bucket 4 so that only the vegetation desired to be killed, such as tall weeds come into contact with the spray bucket 4 and the cloth cover 8.

With reference to FIG. 3, a top view of a spray bucket 4 of the present invention is shown. The spay bucket 4 is preferably substantially V-shaped having a front panel 15, a rear panel 16 and triangular shaped side panels 17. A predetermined portion of the front panel 15 and a predetermined portion of the rear panel 16 comprise a grate 18. The grate 18 provides support for the cloth cover 8 while allowing herbicide that is sprayed on the front panel 15 and rear panel 16 to pass through the grate 18 to the cloth cover 8, thereby saturating the cloth cover 8 in herbicide. One or more spray nozzles 7 are connected to a hose 6 located in an upper portion 19 of the spray bucket 4. A predetermined amount of porous material 20 is located in the lower portion 21 of the spray bucket 4. As herbicide is sprayed on the front panel 15 and rear panel 16, the porous material 20 is also saturated in herbicide, thereby ensuring that the cloth cover 8 remains saturated.

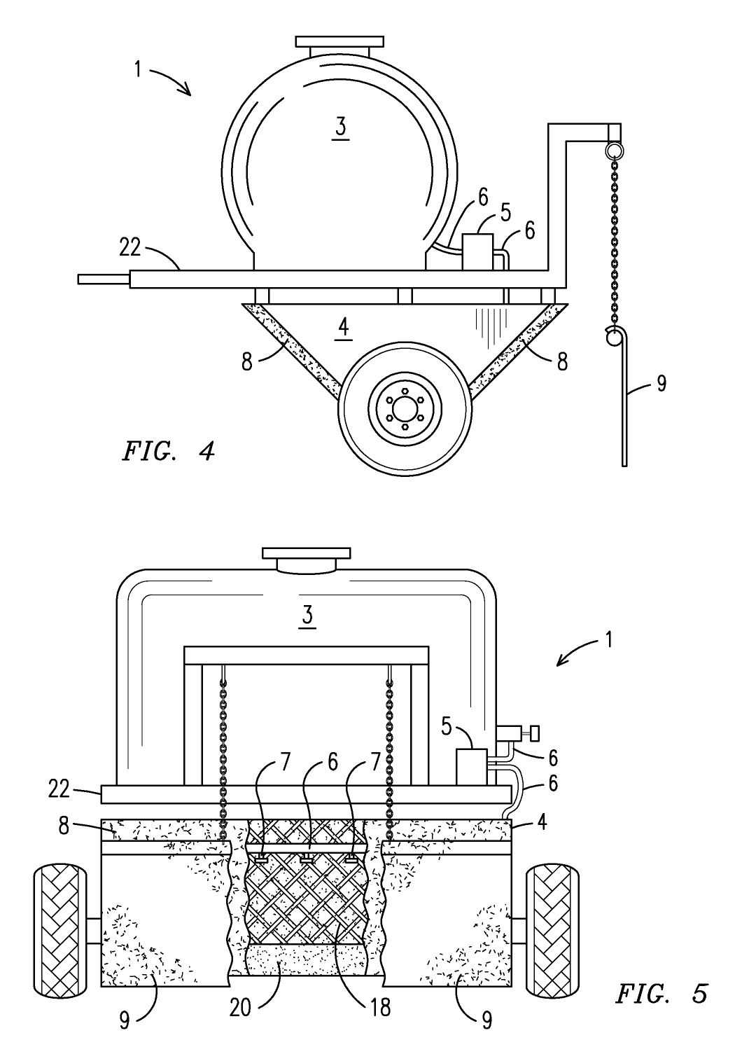

With reference to FIGS. 4 and 5, a side view and a rear partial cutaway view of a herbicide dispersing system 1 of the present invention mounted on a trailer 22, respectively, are shown. The system 1 comprises a storage tank 3 for storing herbicides on top of a trailer. A pump 5 pumps herbicide from the storage tank 3 through hoses 6 to spray nozzles 7 located inside the spray bucket 4, as shown in FIG. 3. The spray bucket 4 is preferably V-shaped and has a cloth cover 8 made of a porous cloth material, such as a heavy felt. The spray nozzles 7 saturate the cloth cover 8 through grates 18 located in the spray bucket, which is then applied onto vegetation as the vegetation comes into contact with the spray bucket 4 and the cloth cover 8. A predetermined amount of porous material 20 is located in the lower portion 21 of the spray bucket 4. A spreader 9 preferably comprising a piece of cloth-like material hangs from a rear portion of the trailer 22. The spreader 9 evens out the herbicide that is applied to vegetation by the spray bucket 4 and cloth cover 8.

It is to be understood that while a preferred embodiment of the invention is illustrated, it is not to be limited to the specific form or arrangement of parts or use herein described and shown. It will be apparent to those skilled in the art that various changes may be made without departing from the scope of the invention and the invention is considered not to be limited to what is shown and described in the specification and drawings.

Having thus described my invention, I claim:

1. A herbicide dispersing system comprising:
a storage tank for storing herbicides;
a pump connected to the storage tank by a hose; and
at least one nozzle connected to the pump by a hose located in an upper portion of a spray bucket having a grate.

2. The herbicide dispersing system of claim 1 wherein:
the spray bucket further comprises a cloth cover located on an external surface of the spray bucket.

3. The herbicide dispersing system of claim 1 wherein:
the spray bucket is substantially V-shaped having a front panel a rear panel and substantially triangular-shaped panels.

4. The herbicide dispersing system of claim 1 wherein:
a predetermined amount of porous material is located in a lower portion of the spray bucket.

5. The herbicide dispersing system of claim 1 further comprising:
a spreader located behind the spray bucket.

6. The herbicide dispersing system of claim 1 further comprising:
a pulley system connected to the spray bucket for raising and lowering the spray bucket.

7. The herbicide dispersing system of claim 6 wherein:
the pulley system further comprises a vertical track slideably attached to the spray bucket; and
a wench connected to the spray bucket by a cable.

8. A herbicide dispersing system comprising:
a storage tank for storing herbicides;
a pump connected to the storage tank by a hose;
at least one nozzle connected to the pump by a hose located in an upper portion of a spray bucket having a grate and a cloth cover located on an external surface of the spray bucket.

9. The herbicide dispersing system of claim 8 wherein:
the spray bucket is substantially V-shaped having a front panel, a rear panel and substantially triangular-shaped panels.

10. The herbicide dispersing system of claim 8 wherein:
a predetermined amount of porous material is located in a lower portion of the spray bucket.

11. The herbicide dispersing system of claim 8 further comprising:
a spreader located behind the spray bucket.

12. The herbicide dispersing system of claim 8 further comprising:
a pulley system connected to the spray bucket for raising and lowering the spray bucket.

13. The herbicide dispersing system of claim 12 wherein:
the pulley system further comprises a vertical track slideably attached to the spray bucket; and
a wench connected to the spray bucket by a cable.

14. A herbicide dispersing system comprising:
a storage tank for storing herbicides;
a pump connected to the storage tank by a hose;
at least one nozzle connected to the pump by a hose located in an upper portion of a spray bucket; and
at least one nozzle connected to the pump by a hose located in an upper portion of a spray bucket having a grate and a cloth cover located on an external surface of the spray bucket.

15. The herbicide dispersing system of claim 14 further comprising:
a pulley system connected to the spray bucket for raising and lowering the spray bucket.

16. The herbicide dispersing system of claim 14 wherein:
a predetermined amount of porous material is located in a lower portion of the spray bucket.

17. The herbicide dispersing system of claim 14 further comprising:
a spreader located behind the spray bucket.

18. The herbicide dispersing system of claim 14 wherein:
the pulley system further comprises a vertical track slideably attached to the spray bucket; and
a wench connected to the spray bucket by a cable.
